(19) United States
(12) Patent Application Publication
(10) Pub. No.: US 2007/0218164 A1
(43) Pub. Date: Sep. 20, 2007

(54) Compositions comprising probiotic and sweetener components

(75) Inventor: Marko Stojanovic, Cincinati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/384,050

(22) Filed: Mar. 17, 2006

(51) Int. Cl. A23K 1/18

(52) U.S. Cl. 426/2

(57) ABSTRACT

Disclosed herein are compositions that may be sufficiently stable such that probiotic microorganisms are present in the compositions at the time of ingestion by a mammal. The compositions comprise: (a) a probiotic component; and (b) a sweetener component; wherein the composition is substantially free of a chewing gum base. Further disclosed are methods of prophylactic, therapeutic treatment or non-therapeutic treatment to alleviate diseases or conditions, or enhance overall health, that affect a mammal comprising administration of a composition as described herein.

### FIELD OF THE INVENTION

The present invention relates to compositions comprising a probiotic component and a sweetener component. The present invention is particularly useful for providing compositions that are sufficiently stable such that probiotic microorganisms are present in the compositions at the time of ingestion by a mammal, such as a human or pet.

### BACKGROUND OF THE INVENTION

Compositions containing probiotic microorganisms are desirable in the art. While various commercial attempts have been made to achieve such compositions, many of these do not provide sufficient efficacious levels of probiotic microorganism whether in live or dormant state due to issues associated with susceptibility of the microorganism to standard commercial pet food manufacturing procedures such as extrusion. For example, with pet food compositions in particular, efforts of coating or filling standard pet food kibbles with probiotic microorganisms have been suggested but, in practice, often prove impractical. To avoid issues associated with standard commercial food manufacture, other manufacturers may provide jars of probiotic microorganism powder for sprinkling on standard foods. However, this raises issues of convenience and compliance such that still further development in this area is necessary to achieve an efficacious composition that will be successful in the marketplace and gain widespread human use and use with pets.

### SUMMARY OF THE INVENTION

The present invention relates to compositions that may be sufficiently stable such that probiotic microorganisms are present in the compositions at the time of ingestion by a mammal. The compositions comprise:
(a) a probiotic component; and
(b) a sweetener component;
   wherein the composition is substantially free of a chewing gum base.

The present invention further relates to methods of prophylactic, therapeutic treatment or non-therapeutic treatment to alleviate diseases or conditions, or enhance overall health, that affect a mammal comprising administration of a composition as described herein. In one embodiment, the invention relates to methods of enhancing gastrointestinal health in a mammal comprising administration of such a composition.

### DETAILED DESCRIPTION OF THE INVENTION

Various documents including, for example, publications and patents, are recited throughout this disclosure. All such documents are, in relevant part, hereby incorporated by reference. The citation of any given document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

All percentages and ratios are calculated by weight unless otherwise indicated. All percentages and ratios are calculated based on the total composition unless otherwise indicated.

Referenced herein are trade names for components including various ingredients utilized in the present invention. The inventors herein do not intend to be limited by materials under a certain trade name. Equivalent materials (e.g., those obtained from a different source under a different name or reference number) to those referenced by trade name may be substituted and utilized in the descriptions herein.

In the description of the invention various embodiments or individual features are disclosed. As will be apparent to the ordinarily skilled practitioner, all combinations of such embodiments and features are possible and can result in preferred executions of the present invention.

The compositions herein may comprise, consist essentially of, or consist of any of the elements as described herein.

While various embodiments and individual features of the present invention have been illustrated and described, various other changes and modifications can be made without departing from the spirit and scope of the invention. As will also be apparent, all combinations of the embodiments and features taught in the foregoing disclosure are possible and can result in preferred executions of the invention.

As used herein, the term “pet” means a domestic animal including, but not limited to domestic dogs, cats, horses, cows, ferrets, rabbits, pigs, and the like. Domestic dogs and cats are preferred herein.

As used herein, the term “viable probiotic microorganism” or the like means a probiotic microorganism in its live state, which by definition herein includes but is not limited to those in the dormant state and spores.

### Compositions of the Present Invention

The present invention relates to compositions that may be sufficiently stable such that. probiotic microorganisms are still live or dormant in the compositions at the time of ingestion by a mammal, thereby maintaining activity of the microorganism. The compositions comprise:
(a) a probiotic component; and
(b) a sweetener component;
   wherein the composition is substantially free of a chewing gum base.

As discovered herein, it is found that the sweetener component is useful for managing the stability of the probiotic component.

The composition may be of any form that is orally administrable. For example, the composition may be in the form of tablets, capsules or the like. These forms may be particularly useful for human use. Other forms may include powders comprising the probiotic and sweetener components, for use in combining with foods ordinarily consumed by a mammal.

The composition herein is substantially free of a chewing gum base. As used herein, the term “chewing gum base” is as defined in WO 03/017951. As also used herein, the term “substantially free of a chewing gum base” means that the composition comprises less than 10%, alternatively less than about 5%, alternatively less than about 2%, alternatively less than about 1%, alternatively 0% of a chewing gum base, by weight of the composition. In one embodiment, it is preferred that the composition herein is substantially free of an elastomer. As used herein, the term “substantially free of an elastomer” means that the composition comprises less than 5%, alternatively less than about 3%, alternatively less than about 1%, alternatively less than about 0.5%, alternatively 0% of an elastomer, by weight of the composition.

In one embodiment, the composition is a pet food composition. As used herein, the term “pet food composition,” means a composition that is intended for ingestion by the pet. Pet food compositions may include, without limitation, nutritionally balanced compositions suitable for daily feed, as well as supplements (e.g., treats, edible films) which may or may not be nutritionally balanced. As such pet food compositions, or components thereof, may or may not be nutritionally balanced. As used herein, the term “nutritionally balanced,” with reference to the pet food composition or a component thereof, means that the composition or component has known required nutrients to sustain life in proper amounts and proportion based on recommendations of recognized authorities in the field of pet nutrition, except for the additional need for water.

Pet food compositions are readily understood in the art, for example, dry foods (e.g., at least partially extruded kibbles) and less brittle foods (e.g., semi-moist foods), or mixtures thereof. Pet food compositions may also be supplements, for example, tablets, capsules, or the like, or other forms such as biscuits, chews, edible films or other treats.

The probiotic component and the sweetener component are described as follows:

The Probiotic Component

The probiotic component comprises one or more yeast or bacterial probiotic microorganisms suitable for pet consumption and effective for improving the microbial balance in the pet gastrointestinal tract or for another benefit, such as disease or condition relief or prophylaxis, to the pet (benefits of the present invention are described in further detail in the Methods section, herein below). Various probiotic microorganisms known in the art are suitable for use in the present invention. See, for example, WO 03/075676, Societe Des Produits Nestle, published Sep. 18, 2003.

In one embodiment of the invention, the probiotic component is selected from the group consisting of bacteria of the genera Bacillus, Bacteroides, Bifidobacterium, Enterococcus (e.g., Enterococcus faecium DSM 10663), Lactobacillus, and Leuconostoc, and combinations thereof. In another embodiment of the invention, the probiotic is selected from bacteria of the genera Bifidobacterium, Lactobacillus, and combinations thereof.

Those of the genera Bacillus may form spores. In one embodiment, the probiotic component does not form a spore.

Non-limiting examples of lactic acid bacteria suitable for use herein include strains of Streptococcus lactis, Streptococcus cremoris, Streptococcus diacetylactis, Streptococcus thermophilus, Lactobacillus bulgaricus, Lactobacillus acidophilus (e.g., Lactobacillus acidophilus strain DSM 13241), Lactobacillus helveticus, Lactobacillus bifidus, Lactobacillus casei, Lactobacillus lactis, Lactobacillus plantarum, Lactobacillus rhamnosus, Lactobacillus delbruekii, Lactobacillus thermophilus, Lactobacillus fermentii, Lactobacillus salivarius, Lactobacillus reuteri, Bifidobacterium longum, Bifidobacterium infantis, Bifidobacterium bifidum, Bifidobacterium animalis, Bifidobacterium pseudolongum, and Pediococcus cerevisiae, or mixtures thereof, preferably Lactobacillus salivarius, Bifidobacterium infantis, or mixtures thereof.

As a non-limiting example, strains of Bifidobacterium isolated from resected and washed human gastrointestinal tract as disclosed in WO 00/42168 are preferred. For example, the Bifidobacterium infantis strain designated UCC35624 may be used, described as being deposited at the National Collections of Industrial and Marine Bacteria Ltd (NCIMB) on Jan. 13, 1999, and accorded the accession number NCIMB 41003. Strains isolated from resected and washed canine or feline gastrointestinal tract may be particularly useful.

As another non-limiting example, strains of Lactobacillus salivarius isolated from resected and washed human gastrointestinal tract as described in WO 98/35014 are preferred. More preferred are the Lactobacillus salivarius strains that are designated UCC 1 and UCC 118, described as being deposited at the National Collections of Industrial and Marine Bacteria Ltd (NCIMB) on Nov. 27, 1996, and accorded the accession numbers NCIMB 40830 and 40829, respectively.

In one embodiment, the compositions of the present invention have a viable probiotic microorganism count of at least about 10⁵ colony forming units (CFU) per gram of composition, or at least about 10⁶ CFU per gram of composition, or at least about 10⁸ CFU per gram of composition. For example, the composition may have a viable probiotic microorganism count of up to about 10¹⁴ CFU per gram of composition, up to about 10¹² CFU per gram of composition, or up to about 10¹⁰ CFU per gram of composition, or up to about 10⁹ CFU per gram of composition. CFU is determined using the method provided as part of the European Pharmacopoeial Methods, 2003, Section 2.6.12. Advantageously, the composition provided herein has a shelf life of at least about three months, alternatively at least about six months, alternatively from about three months to about twenty-four months, alternatively from about six months to about eighteen months. As used herein, the term “shelf life” refers to that property of the composition whereby about 1% or more, alternatively about 5% or more, alternatively about 10% or more, alternatively about 25% or more, alternatively about 50% or more, alternatively about 75% or more, of the probiotic microorganisms of the composition are viable at the referenced time period after exposure to ambient environmental conditions.

As further examples, the compositions may comprise at least about 0.001%, alternatively at least about 0.01%, alternatively at least about 0.1%, alternatively at least about 0.5%, and alternatively at least about 1% of the probiotic component, by weight of the composition. As further examples, the compositions may comprise about 99% or less, alternatively about 75% or less, alternatively about 50% or less, alternatively about 25% or less, alternatively about 10% or less, and alternatively about 5% or less of the probiotic component, by weight of the composition.

The Sweetener Component

The compositions herein comprise a sweetener component, which is found useful for probiotic component stability. The sweetener component, as defined herein, is a monosaccharide, disaccharide, or any mixture thereof.

In one embodiment, the compositions herein comprise a monosaccharide. The monosaccharide utilized herein is of the general formula CₙH₂ₙOₙ , wherein n is an integer equal to or greater than 3. Non-limiting examples of monosaccharides that may be used include sorbitol, mannitol, erythrose, threose, ribose, arabinose, xylose, ribulose, glucose, galactose, mannose, fructose, sorbose, and any mixture thereof. In one embodiment, the monosaccharide may include sorbitol, mannitol, glucose, mannose, fructose, or any mixture thereof. In another embodiment, the monosaccharide is sorbitol.

In one embodiment, the compositions herein comprise a disaccharide. The disaccharide utilized herein is of the general formula CₙH₂ₙ₋₂Oₙ₋₁, wherein the disaccharide has 2 monosaccharide units connected via a glycosidic bond. In such formula, n is an integer equal to or greater than 3. Non-limiting examples of disaccharides that may be utilized herein include sucrose, maltose, lactitol, maltitol, maltulose, lactose, and any mixture thereof. In another embodiment, the monosaccharide is sucrose.

In one embodiment, which may be particularly advantageous to stability of the probiotic component wherein a sweetener component is utilized, the sweetener component comprises a monosaccharide or disaccharide having a melting point of from about 80° C. to about 140° C., or from about 90° C. to about 120° C. Non-limiting examples include monosaccharides, such as sorbitol or xylitol.

As examples, the compositions herein may comprise at least about 0.001%, or at least about 0.1%, or at least about 1% or at least about 5%, or at least about 10%, or at least about 20% of the sweetener component, all by weight of the composition. As further examples, the compositions herein may comprise about 99% or less, or about 90% or less, or about 95% or less, or about 75% or less, or about 50% or less of the sweetener component, all by weight of the composition.

Illustrative Optional Components

The present composition may optionally comprise one or more further components, for example an optional component as described herein.

In one embodiment, the compositions may comprise, on a dry matter basis, from about 20% to about 50% crude protein, or from about 22% to about 40% crude protein, by weight of the composition. The crude protein material may comprise any material having a protein content of at least about 15% by weight, non-limiting examples of which include vegetable proteins such as soybean, cottonseed, and peanut, animal proteins such as casein, albumin, and meat tissue. Non-limiting examples of meat tissue useful herein include fresh meat, and dried or rendered meals such as fish meal, poultry meal, meat meal, bone meal, and the like. Other types of suitable crude protein sources include wheat gluten or corn gluten, and proteins extracted from microbial sources such as yeast.

The compositions may comprise a source of fat. In one embodiment, the compositions may comprise, on a dry matter basis, from about 5% to about 35% fat, preferably from about 10% to about 30% fat, by weight of the composition. Sources of fat are widely known, and as used herein are interpreted to include (as examples) wax, fat, fatty acid, and/or lipid.

Specific examples of wax, fat, fatty acid, or lipid may often be interchangeable in accordance with nomenclature common in the art; for example, a lipid may often also be characterized as a fat. The inventors herein do not intend to be limited by any particular designation of nomenclature, and classifications of a particular material as a wax, fat, fatty acid, lipid, or the like is made for purposes of convenience only.

For example, the fat may comprise a cocoa butter component. As defined herein the cocoa butter component comprises one or more of cocoa butter, a cocoa butter extender, a cocoa butter replacer, or a cocoa butter substitute. A given fat may be classified as one of a cocoa butter extender, cocoa butter replacer, or cocoa butter substitute, or sometimes may be classified as two or more of a cocoa butter extender, cocoa butter replacer, and cocoa butter substitute. Where used, each of the cocoa butter extender, cocoa butter replacer, and cocoa butter substitute may be one particular fat within the referenced class or any mixtures of such fats.

Cocoa butter is commonly known in the art and may generally refer to the fat from cocoa beans used to prepare chocolate. Cocoa beans are obtainable from the pods of cacao trees (e.g., Theobroma cacao).

The cocoa butter component may additionally or alternatively comprise a cocoa butter extender. These extenders are also commonly known in the art, and may generally refer to other fats having solid fat index (SFI) profiles which are similar to cocoa butter. Cocoa butter extenders may comprise fat containing C₁₆ or C₁₈ fatty acids, or combinations thereof. Palm oil, shea oil, illipe butter, cottonseed oil, and soybean oil, including fractionated and/or partially hydrogenated forms, are non-limiting examples of cocoa butter extenders.

The cocoa butter component may additionally or alternatively comprise a cocoa butter replacer. These replacers will also be commonly known in the art, and may generally refer to fats having melting or other properties, or structures, similar to those of cocoa butter, which are based on non-lauric fats (e.g., C₁₆ or C₁₈). These include vegetable oils such as palm oil, cottonseed oil, soybean oil, and rapeseed oil, including fractions and/or partially hydrogenated forms thereof. One example is ASTRAL® R (partially hydrogenated vegetable oil (soybean oil and cottonseed oil), commercially available from Humko Oil Products, Cordova, Tenn.).

The cocoa butter component may additionally or alternatively comprise a cocoa butter substitute. These substitutes will also be commonly known in the art, and may generally refer to hard fats having melting or other properties, or structures, similar to those of cocoa butter, but which are based on lauric fats (C₁₂). Such cocoa butter substitutes may tend to have melting points higher than that of cocoa butter, making these substitutes interesting for imparting heat resistance to compositions. These include vegetable oils such as palm kernel oil and coconut oil, including fractions and/or partially hydrogenated forms thereof.

In one embodiment, the cocoa butter component comprises at least one lipid selected from the group consisting of soybean oil, cottonseed oil, coconut oil, rapeseed oil, palm kernel oil, fractions of the foregoing, and partially hydrogenated forms of the foregoing.

Alternatively or additionally, the fat may comprise an animal-derived fat component. As will be commonly known in the art, the animal-derived fat component comprises a fat derived from an animal. Non-limiting examples include beef, poultry, pork, and lamb. (e.g., lards and tallows). Dairy fats may also be examples, including milkfat, fractionated milkfat, and butterfat.

In one embodiment, the fat may comprise a combination of a cocoa butter component and an animal-derived fat component at a ratio of from about 5:95 to about 95:5, or from about 5:95 to about 25:75, or from about 5:95 to about 50:50, all by weight. In another embodiment herein, the fat comprises the cocoa butter component and the animal-derived fat component at a ratio of from about 20:80 to about 45:55, or from about 25:75 to about 40:60, all by weight.

Alternatively or additionally, the fat may comprise a fatty acid. Illustrative sources include omega-3 or omega-6 fatty acids.

Omega-3-fatty acids are preferably derived from marine (fish) sources, including menhaden (a herring-like fish) and, as such, may be derived from such sources. Non-limiting examples of omega-3-fatty acid sources include docosahexaenoic acid (“DHA”) or eicosapentaenoic acid (“EPA”), such as OMEGAPURE, commercially available from Omega Protein, Inc., Houston, Tex. All forms of the fatty acid are also contemplated herein. For example, DHA is often provided as a triglyceride. As such, wherein a specific fatty acid is mentioned (e.g., “DHA”), such fatty acid includes the free form of the fatty acid as well as other forms such as the naturally occurring triglyceride or other form. The terms, DHA, EPA, or other specific terms are utilized for convenience as will be commonly understood in the art to include all forms of such termed material.

Omega-6-fatty acids may be utilized herein. As is well-understood in the art, omega-6-fatty acids are those fatty acid materials having a double bond positioned between the sixth and seventh carbon atoms of the fatty acid chain, when counting from the omega (distal) carbon atom of the chain.

Other examples of suitable fatty acids may include oleic acid, stearic acid, palmitic acid, and lauric acids, including suitable salts thereof. Even further examples of suitable fatty acids include esters or other derivatives thereof, such as cetyl palmitate, acetic, lactic, or citric mono- and di-glyceride fatty acids, isopropyl palmitate, isopropylmyristate, and mono-, di-, and triglycerides (some of which may also be characterized as fats).

The compositions may comprise a mixture of omega-3-fatty acids and omega-6-fatty acids, often through utilization of various materials containing these components. Certain compositions for use herein may be enriched in one or more specific omega-3-fatty acids or omega-6-fatty acids.

Alternatively or additionally, the compositions may comprise wax. For example, illustrative waxes include paraffin wax, beeswax (e.g., white or yellow), carnuba wax, candellila wax, microcrystalline wax, rice bran wax, cetyl ester wax, and emulsifying wax.

Alternatively or additionally, the compositions may comprise a polysaccharide such as shellac or chitin.

The compositions herein may optionally comprise a source of carbohydrate. Grains or cereals such as rice, corn, milo, sorghum, barley, alfalfa, wheat, and the like are illustrative sources of carbohydrate. These carbohydrate sources, and typical levels thereof, are widely known.

The compositions may comprise a component such as dried whey or other dairy by-products.

The compositions may comprise a fermentable fiber. Fermentable fibers are well-known in the art. The fermentable fiber may be any fiber source which intestinal bacteria present in the animal can ferment to produce short chain fatty acids or other metabolic components. Non-limiting examples of such fermentable fibers include beet pulp (from sugar beet), gum arabic, gum talha, psyllium, rice bran, carob bean gum, citrus pulp, pectin, fructooligosaccharide, mannanoligofructose, soy fiber, arabinogalactan, galactooligosaccharide, arabinoxylan, and mixtures thereof.

In general, fermentable fibers are not digested by mammals but may be metabolized by intestinal bacterial species, such as Bifidobacterium. However, not all intestinal bacteria can metabolize fermentable fiber. In particular, bacteria such as Salmonella, E. coli and Clostridia are unable to process such fiber to any meaningful degree. This preferential digestibility, which is applicable for fermentable fiber as a class, can be used to improve the overall bacterial flora in the small intestine of the companion animal. Because fermentable fibers will only feed “good” bacteria such as Lactobacillus and Bifidobacterium, the amounts of harmful bacteria such as Salmonella, E. coli and Clostridia may decrease due to a reduction in food resources. Therefore, by providing a preferred food source for beneficial bacterial species, a diet supplemented with fermentable fiber can increase “good” intestinal bacteria while reducing the amount of “bad” bacteria.

Beet pulp and fructooligosaccharide, particularly short chain oligofructose, are particularly preferred fermentable fibers for use herein. As an example, fructooliogosaccharides are naturally occurring compounds which can be found in a variety of fruits or vegetables including banana, barley, garlic, honey, onion, rye, brown sugar, tomato, asparagus, artichoke, wheat, yacon, or chicory. Fructooligosaccharide may for example be provided as chicory root, as a long chain oligofructose (e.g., inulin), or as short chain oligofructose. Particularly useful herein are fructooligosaccharide comprising at least one of 1-kestose (abbreviated as GF₂), nystose (GF₃), and 1F-beta-fructofuranosylnystose (GF₄). While fructooligosaccharides can be extracted from plants such as those mentioned herein, they can also be formed artificially by adding one, two, or three fructose units to a sucrose molecule by a B-(2-1)-glycosidic linkage of the fructose unit(s) to the fructose unit of sucrose. As an example, fructooligosaccharides are commercially available under the tradename NUTRAFLORA from Golden Technologies Company, Incorporated (which is a short chain oligofructose comprising 1-kestose, nystose, and 1F-beta-fructofuranosylnystose. As another example, a mixture of short chain fructooligosaccharide and inulin can be PREBIO1 or a mixture of commercially available RAFTILOSE and RAFTILINE.

The fructooligosaccharide may be a short chain oligofructose, which will be well-known to those of ordinary skill in the art. Particularly useful herein are short chain oligofructose comprising 1-kestose (abbreviated as GF₂), nystose (GF₃), and 1F-beta-fructofuranosylnystose (GF₄). In a preferred embodiment, the short chain oligofructose comprises from about 25% to about 45% 1-kestose, from about 25% to about 45% nystose, and from about 1% to about 20% 1F-beta-fructofuranosylnystose, by weight of the short chain oligofructose, alternatively from about 30% to about 40% 1-kestose, from about 50% to about 60% nystose, and from about 5% to about 15% 1F-beta-fructofuranosylnystose, by weight of the short chain oligofructose. As an example, short chain oligofructose is commercially available under the tradename NUTRAFLORA from Golden Technologies Company, Incorporated (which is a short chain oligofructose comprising about 35% 1-kestose, 55% nystose, and 10% 1F-beta-fructofuranosylnystose, all by weight of the short chain oligofructose).

In an embodiment herein, the fermentable fibers may display certain organic matter disappearance percentages. In this optional embodiment, the fermentable fibers may have an organic matter disappearance (OMD) of from about 15% to about 60% when fermented by fecal bacteria in vitro over a 24 hour period. That is, from about 15% to about 50% of the total organic matter originally present is fermented and converted by the fecal bacteria. The organic matter disappearance of the fibers is alternatively from about 20% to about 50%, alternatively from about 30% to about 40%.

Thus, in vitro OMD percentage may be calculated as follows:
(1—((OM residue−OM blank)/original OM))×100
where OM residue is the organic matter recovered after 24 hours of fermentation, OM blank is the organic matter recovered in corresponding blank tubes (i.e., tubes containing medium and diluted feces, but no substrate), and original OM is that organic matter placed into the tube prior to fermentation. Additional details of the procedure are found in Sunvold et al., J. Anim. Sci., Vol. 73, pp. 1099-1109 (1995).

In one embodiment herein, the compositions may comprise at least about 0.25% total fermentable fiber, by weight of the composition. By “total fermentable fiber” it is meant that the referenced level is determined by adding the relative amounts of each fermentable fiber present in the composition. For example, wherein a composition comprises 1% fructooligosaccharide and 0.5% beet pulp, by weight of the composition, and no other fermentable fiber, the composition comprises 1.5% total fermentable fiber, by weight of the composition. Alternatively, the present compositions may comprise at least about 0.5% total fermentable fiber, at least about 1% total fermentable fiber, at least about 2% total fermentable fiber, alternatively from about 1% to about 20% total fermentable fiber, alternatively from about 1% to about 10% total fermentable fiber, alternatively from about 2% to about 10% total fermentable fiber, or alternatively from about 3% to about 8% total fermentable fiber, all by weight of the pet food composition.

A suitable process for the preparation of pet food compositions is at least partial extrusion, although baking and other suitable processes may be used. When extruded, the dried pet food is usually provided in the form of a kibble. A process is described in EP 0,850,569.

In one embodiment herein, the compositions may comprise a nutraceutical. Nutraceutical as used herein means a foodstuff (as a fortified food or dietary supplement) that provides health benefits.

The compositions herein may comprise any of a variety of components that are sensitive to process conditions ordinarily attendant with manufacture of a pet food. For example, the integrity of such sensitive components may be preserved (either fully or partially). Non-limiting examples of sensitive components include components that exhibit more than about 10% loss (by weight) during standard extrusion processes when included within a standard, commercial pet food, alternatively more than about 20% loss, alternatively more than about 50% loss. Extrusion processes are well-known in the art. Included or alternative examples of sensitive components including antioxidants such as vitamins including but not limited to vitamin A (including forms thereof, such as beta-carotene and lycopenes), vitamin C (including forms thereof), vitamin E (including forms thereof), vitamin D (including forms thereof), Phenols, Carotenoids, Alkaloids, Xanthones, Polyphenols, Beta-Carotene, OrganoSulfur, Curcumin, Kaempherol, Astaxanthin, Gamma-Glutamylcysteines, Catechins, Pterostilbene , Canthaxanthin, Cysteine Sulfoxides, Ellagic Acid, Quercetin, Tunaxanthin, Isothiocyanates, Baicalin, Tocopherols, Myricetin, Zeaxanthin, Flavonoids, Resveratrol, Anthocyanins, Bixin, Isoflavonoids, Vinpocetine, Flavonols, Lutein, Co-Q10, Proanthocyanidins, Lycopene, Lipoic Acid and the like.

Additional material that can be present in the composition of the present invention include minerals such as but not limited to Calcium Carbonate, Calcium, Boron, Selenium, Calcium Chloride, Chloride, Ferrous Fumarate, Zinc Acetate, Choline Chloride, Chromium, Ferrous Gluconate, Zinc Sulfate, Chromium, Tripicolinate, Cobalt, Magnesium Oxide, Zinc Gluconate, Dicalcium Phosphate, Copper, Magnesium Sulfate, Ferrous Sulfate, Iodine, Magnesium Carbonate, Monosodium Phosphate, Iron, Chromium Picolinate, Potassium Chloride, Magnesium, Calcium Citrate, Potassium Citrate, Manganese, Calcium Lactate, Potassium Sorbate, Phosphorus, Calcium Gluconate, Sodium Bisulfate, Potassium, Chromium Chloride, Sodium Hexametaphosphate, Sodium, Chromium Nicotinate, Tricalcium Phosphate, Zinc, Chromium Citrate, Yeast containing any of these minerals and the like.

Methods of the Present Invention

The present compositions can be used to deliver benefit following oral consumption in animals, preferably a pet. This benefit generally maintains and improves the overall health of the animal. Non-limiting elements of animal health and physiology that benefit, either in therapeutically relieving the symptoms of, or disease prevention by prophylaxis, or improvement of overall health, including treatment of the immune system, treatment of the gastrointestinal system, treatment of skin or coat, treatment of stress, and combinations thereof. Non-limiting examples include inflammatory disorders, immunodeficiency, inflammatory bowel disease, irritable bowel syndrome, cancer (particularly those of the gastrointestinal and immune systems), otitis externa, diarrhoeal disease, antibiotic associated diarrhoea, appendicitis, autoimmune disorders, multiple sclerosis, Alzheimer's disease, amyloidosis, rheumatoid arthritis, arthritis, joint mobility, hip dysplasia, diabetes mellitus, insulin resistance, bacterial infections, viral infections, flngal infections, periodontal disease, urogenital disease, idiopathic cystitis, interstitial cystitis, surgical associated trauma, surgical-induced metastatic disease, sepsis, weight loss, weight gain, excessive adipose tissue accumulation, anorexia, fever control, cachexia, wound healing, ulcers, gut barrier infection, allergy, asthma, respiratory disorders, circulatory disorders, coronary heart disease, anaemia, disorders of the blood coagulation system, renal disease, disorders of the central nervous system, hepatic disease, ischaemia, nutritional disorders, treatment or prevention of disorders involving the hypothalamus-pituitary-adrenal (HPA) axis, osteoporosis, endocrine disorders, and epidermal disorders. Preferred are treatment of the gastrointestinal tract, including treatment or prevention of diarrhea, immune system regulation, preferably the treatment or prevention of autoimmune disease and inflammation, maintaining or improving the health of the skin and/or coat system, preferably treating or preventing a topic disease of the skin, treatment or prevention of disorders involving the hypothalamus-pituitary-adrenal (HPA) axis, ameliorating or reducing the effects of aging, including mental awareness and activity levels, and preventing weight loss during and following infection.

Immune Regulation

The treatment of the disorders disclosed above may be measured using techniques known to those skilled in the art. For example, inflammatory disorders including autoimmune disease and inflammation may be detected and monitored using in vivo immune function tests such as lymphocyte blastogenesis, natural killer cell activity, antibody response to vaccines, delayed-type hypersensitivity, and mixtures thereof. Such methods are briefly described herein, but are also well known to those skilled in the art.
1. Lymphocyte blastogenesis: This assay measures the proliferative response in vitro of lymphocytes isolated from fresh whole blood of test and control animals to various mitogens and is a measure of overall T- and B-cell function. Briefly, peripheral blood mononucleocytes (PBMC) are isolated from whole blood by Ficoll-Hypaque density centrifugation methods known to those skilled in the art. The isolated PBMCs are washed twice in RPMI 1640 cell media supplemented with HEPES, L-glutamine and penicillin/streptomycin. The washed cells are resuspended in RPMI 1640, counted, and the cell density adjusted appropriately. The 2×10⁵ cells are exposed to a range of concentrations (0.1 μg/ml to 100 μg/ml) of various mitogens, some examples of which include pokeweed mitogen (Gibco), phytohaemagglutinin (Gibco) and conconavalin A (Sigma) in triplicate for 72 hours at 37° C. and 5% CO₂ with 10% foetal bovine serum (Sigma). At 54 hours the cells are pulsed with 1 μCi ³H-thymidine, and the cells harvested and scintillation counts read on a TopCount NXT at 72 hours.
2. Natural killer cell activity: As described in U.S. Pat. No. 6,310,090, this assay measures the in vitro effector activity of natural killer cells isolated from fresh whole blood of test and control animals. Natural killer cells are a component of the innate immune function of a mammal. Canine thyroid adenocarcinoma cells are used as target cells in assessing NK cell cytotoxic activity. This cell line is previously shown to be susceptible to killing by canine NK cell. Target cells are cultured in a T75 flask with 20 mL minimum essential medium (MEM; Sigma Chem. Co., St. Louis, Mo.) supplemented with 10% fetal calf serum (FCS), 100 U/mL of penicillin and 100 μg/mL of streptomycin. When confluent, target cells are trypsinized, washed 3 times and resuspended to 5×10⁵ cells/mL in complete medium (RPMI-1640+10% FCS+100 U/mL of penicillin+100 μg/mL of streptomycin). Triplicate 100 μL aliquots of the target cells are pipetted into 96-well U-bottom plates (Costar, Cambridge, Mass.) and incubated for 8 hours to allow cell adherence. Lymphocytes (effector cells; 100 μL) isolated by Ficoll-Hypaque separation (as described above) are then added to the target cells to provide an effector/target cell (E:T) ratio of 10:1. After 10 hours of incubation at 37° C., 20 μl of a substrate containing 5 μg of 3-(4,5-dimethylthiazol-2-yl)-2,5-diphenyltetrazolium bromide (MTT) is added. The mixture is incubated for 4 hours at 37° C. after which the unmetabolized MTT is removed by aspiration. The formazan crystals are dissolved by adding 200 μL of 95% ethanol. Optical density is measured at 570 nm using a microplate reader. The percentage of NK cell-specific lysis is calculated as follows:
   Specific Cytotoxicity (%)=100×{1−[(OD of target cells and effector cells−OD of effector cells)/(OD of target cells)]}
3. Antibody response to vaccines: The test subjects are given an array (up to 5) of vaccines after at least 12 weeks of probiotic or control feeding. The vaccines may be a mixture of novel and redundant vaccines. Non-limiting examples of vaccine arrays that may be used include mixtures of vaccines prepared by Fort Dodge Animal Health. Non-limiting examples of vaccines suitable for use herein include Canine distemper, adenovirus, coronavirus, parainfluenza, and parvovirus. The test subject's vaccine history will determine the vaccines to be used. The specific antibodies to the vaccines given are measured in blood for 3 weeks and the length and strength of response in control and probiotic feeding groups compared.
4. Delayed-type hypersensitivity: This is an in vivo, non-invasive method of assessing immune system status. This test comprises an intradermal injection of the polyclonal mitogen Phytohemmaglutinin (PHA) in combination with sheep red blood cells a multivalent vaccine, histamine (100 μL of 0.0275 g/L Histamine Phosphate; Greer, Lenoir, N.C.), or PBS (100 μL of Phosphate Buffered Saline, 8.5 g/L; Sigma). The immune response to the antigen is recorded as skinfold thickness using calipers at time intervals of 0, 24, 48 and 72 hours post-injection. An increase in skinfold thickness is indicative of a greater hypersensitivity response that should be decreased by treatment with the bacteria of the present invention.

Additional methods for determining the effect of the compositions of present invention are described in U.S. Pat. Nos. 6,133,323 and 6,310,090.

Body Composition

Ameliorating the effects of age may be determined using dual x-ray absorptometry or computed tomography (CT) scan for measuring body composition, including body fat mass, fat-free mass and bone mineral content. Similarly, this method may be used to determine anatomy changes such as weight loss or bone density in subjects following infection.

Stress Reduction

The present invention may also be used in a method for reducing disorders associated with over-activity of the hypothalamus-pituitary-adrenal (HPA) axis such as reducing stress levels, including improving mood or reducing depression in pets. Concentrations of blood stress hormones including epinephrine, norepinephrine, dopamine, cortisol and C-reactive protein may be measured to determine stress levels and their reduction or maintenance. These hormones are recognized biomarkers of stress and can be readily measured using techniques known to those skilled in the art. Additionally, since adrenal hypertrophy is a consequence of increased activity of the HPA axis, direct measurement of adrenal size by CT imaging may also be employed. The biochemical and physiological measurements of HPA axis activity may also be accompanied by behavioral assessment to confirm the mammal's mood or level of stress.

Skin and Coat Health

Further still, maintenance or improvement of the health of the skin or coat system of pets, including a topic disease of the skin, improving skin barrier function or optimizing the microbial ecology of the skin, may be measured using skin and coat assessments conducted by two trained individuals. Examples of criteria examined during such assessments include:
a) Shedding index: A shedding index is assigned to each test subject by collecting hair produced during a standardized brushing session. The hair is retained and weighed, and control and test subjects compared.
b) Subjective skin/coat evaluations: Trained panelists subjectively evaluate skin and coat condition by assessing shedding, dander, shine, uniformity, softness and density.
c) Skin functional assessment: The barrier function of the skin may be assessed by wiping the skin surface with an acetone-soaked gauze. This technique effectively disrupts the skin barrier by removing single cell layers and associated lipid fractions of the stratum corneum. Barrier disruption is quantified by measuring the increase in transepidermal water loss (TEWL) and the degree of redness of the insulted site using methods known to those skilled in the art. Redness (erythema) scores are obtained using the previously described camera and lighting system. TEWL readings and redness scores are obtained immediately before and after disruption, and at five and 24-hour endpoints to assess the protective and healing properties of skin.
   Gastrointestinal Health

The use of the present invention to improve intestinal health or treat or prevent intestinal diseases, including diarrhoea and inflammatory bowel disease, in pets may be measured using stool scores. Stools scores may be recorded daily according to the following guidelines and control and test groups compared before and after feeding with the bacteria according to the present invention.

Score: 5 Extremely Dry

This stool is hard and does not stick to surfaces. Stool will roll when pushed. No indentations are made when stool is picked up. Stool is often defecated in groups of individual stools instead of one complete unit. The stool maintains original shape after collection.

Score: 4 Firm (Ideal Stool)

This stool is firm, well shaped, and cylindrical. This stool does not break apart easily when picked up. This stool may leave residue on surfaces and gloves. This stool is often defecated as one unit. The stool maintains original shape after collection.

Score: 3 Soft, with Shape

This stool is soft, however there are definite shapes. This stool will break apart easily and will definitely leave residue on surfaces and gloves. The stool often loses original shape after collection. This stool is often present with another score but can comprise whole stool sample.

Score: 2 Soft, without Shape

This stool is soft and will have no cylindrical shape. The shape often associated with a “2” is a “cow patty” shape. This stool will lose the original shape when collected and will definitely leave residue on surfaces and gloves. This stool score is often present with another score but can comprise the whole stool sample. This stool sample may spread over an area of several inches.

Score: 1 Liquid

This stool score will always resemble liquid and there may or may not be particulate matter present. This stool will often be defecated in groups of piles instead of one complete unit. Mucous is often present with this stool sample. This stool sample is very difficult to collect and residue is always left on surfaces and gloves. This stool sample may spread over an area of several inches.

In addition, other observations are also recorded, including: blood in stool; foreign object in stool; or mucous in stool.

The methods of use of the present invention may be used to reduce the odor of the feces and/or litterbox by reducing the production of compounds in the feces and urine that cause odor. Non-limiting examples of odor-causing compounds include ammonia, indoles, phenols, amines, branched chain fatty acids, and volatile sulphur-containing compounds. For example, fecal ammonia concentrations can be measured after treating animals with the present invention using the following methods: fresh fecal samples (5.0 g as is) are weighed into plastic vials containing 40 mL 2 N HCl. The samples are stored at 4° C. until the end of the sampling period. The samples then are prepared (Erwin et al., 1961) for analysis of NH₃ N and lactate. The supemate of such preparation is used for analysis of NH₃ N (Chaney and Marbach, 1962) and lactate (Baker and Summerson, 1941) calorimetrically. Additionally, perceived fecal odor can be scored by humans as follows: Upon collection of fecal samples, they are scored for odor by trained personnel. Fecal odor score is also based on a 1 to 5 scale with 1 being the least smell and 5 being the most.

Furthermore, the treatment of gastrointestinal infection in pets may comprise improving intestinal microbial ecology of pets. Improving the microbial ecology of pets preferably comprises reducing the levels of pathogenic bacteria in the faeces of pets. The levels of pathogenic bacteria present in the faeces of pets may be enumerated using the standard plate count method known to those skilled in the art. More preferably, the pathogenic bacteria are selected from the group consisting of Clostridia, Escherichia, Salmonella, Bacteroides, Campylobacter and mixtures thereof. Non-limiting examples of suitable strains of pathogenic bacteria include C. perfringens, C. difficile, Eschericia coli, Salmonella typhimurium and mixtures thereof.

Urinary Tract Health

Methods of the present invention may also include the treatment, either prophylactic or therapeutic of the urinary tract of animals, preferably pets. Non-limiting examples of urinary tract treatment include treatment or prevention of urinary tract infections, treatment or prevention of kidney disease, including urinary tract stones, treatment or prevention of bladder infections and the like. Without being bound by theory, it is believed that the present invention is useful in preventing these ailments as a result of their ability to degrade oxalic acid-, struvite- or urate-containing crystals as demonstrated in vitro. Oxalic acid is a by-product of urinary metabolism that can form insoluble precipitates that result in kidney, bladder and other urinary tract stone and result in infections. By degrading enteric oxalic acid, and therefore potentially preventing its precipitation and build up in the urinary tract, the present invention may treat and prevent infections and other ailments of the urinary tract. Oxalic acid degradation may be measured in vitro using the Oxalic acid test kit cat # 755699 commercially available from Boehringer Mannheim/R-Biopharm and measured in samples of urine by High Performance Liquid Chromotography.

Nutrient Digestion

The present invention may be used in a method for improving or maintaining the health of pets comprising improving fiber, fat, protein, vitamin and mineral digestion or absorption (collectively referred to as “nutrient digestion”). Improving fiber digestion is desirable as it promotes the growth of said probiotic bacteria, as well as beneficial endogenous microflora, which aid in the suppression of some potentially pathogenic bacteria. In addition, a decrease in the amount of toxic metabolites and detrimental enzymes that result from colonic fermentation has been documented in humans (Tomomatsu, “Health effects of oligosaccharides”, (1994) Food Technol, Vol. 48, pp. 61-65). Fiber digestion may be determined using the method described in Vickers et al., “Comparison of fermentation of selected fructooligosaccharides and other fiber substrates by canine colonic microflora”, (2001) Am. J. Vet. Res., Vol. 61, No. 4, pp. 609-615, with the exception that instead of inoculating using diluted fecal samples each experiment used pure cultures of the bacterial strains of interest.

Joint Health

Furthermore, the present invention may be used to treat or prevent joint disorders in pets thereby increasing activity and quality of life of these animals. Examples of joint disorders include compromised mobility, osteoarthritis, rheumatoid arthritis, hip, elbow and knee dysplasia, spondylosis, and post-trauma joint inflammation. For example, dogs with some degree of lameness may be fed the present composition for a total of 90 days and would be examined by a veterinarian at day 0, 30, 60, and 90 days for body weight, body condition score, skin and coat evaluation and an orthopedic evaluation. The orthopedic evaluation will include degree of lameness, weight bearing, resistance to challenged weight bearing, rear leg extension, and visual impact on the dog's ability to walk and trot. Joint angles and range of motion may also be determined by manual goniometric measurements. Additionally, force-plate analysis could be used to determine joint health. Owners complete questionnaires at day 0, 30, 60, and 90 to assess the overall quality of life and perceived joint health of the animal.

In one embodiment, the methods relate to oral administration of a composition described herein directly to a pet. The various embodiments of the composition used in this method, including forms or the composition and levels of various components contained therein, are described in detail herein.

As used herein with respect to the processes of this invention, the terms “orally administering,” “oral administration” or the like means that the pet ingests or is directed to ingest one or more compositions described herein, or the owner of such pet is directed to provide one or more compositions to the pet. Wherein the owner is directed to provide, such direction may be that which instructs or informs the owner that use of the composition may or will provide one or more of the benefits described herein, such as treatment of the gastrointestinal tract or other methods of use described herein. Additionally or alternatively, the direction may be that the composition contains live probiotic cultures (including, optionally, direction regarding level of live probiotic cultures that are present or guaranteed). For example, such direction may be oral direction (e.g., through oral instruction from, for example, a veterinarian, other health professional, sales professional or organization, and/or radio or television media (i.e., advertisement) or written direction (e.g., through written direction from, for example, a veterinarian or other health professional (e.g., scripts), sales professional or organization (e.g., through, for example, marketing brochures, pamphlets, or other instructive paraphernalia), written media (e.g., internet, electronic mail, or other computer-related media), and/or containing devices associated with the composition (e.g., a label present on a package containing the composition).

The compositions may be administered in accordance with a variety of frequencies or durations. For example, the compositions are typically administered at least once weekly, or at least three times weekly, or from once daily to about four times daily, alternately from once daily to about three times daily, alternately from once daily to about two times daily, alternatively ad libitum. JIn order to achieve the benefits herein, it is preferred that the compositions are administered for at least about one week, alternatively at least about two weeks, alternately at least about three weeks, alternately at least about four weeks, alternately at least about 6 weeks, alternately at least about eight weeks, or in an unlimited duration.

In one embodiment the pet food composition may be an edible film. The edible film can include an applied coating and at least one film layer, at least two film layers.

The film layer is made from any polymer, softener, filler, matrix, or other composition. The film has an acceptable dissolution rate in the oral cavity for a particular thickness of film. For example, if the film has a thickness of 50 microns, it may be desirable for the film to dissolve in the oral cavity within about fifteen seconds. Or it may be desirable for the film to dissolve more slowly. By way of example, and not limitation, the film can be made with pullulan, modified starch, pectin, carageenan, a maltrodextrin, or alginate. The applied coating can comprise the composition and levels of various components contained therein, and are described in detail herein. Preferably the applied coating contains the probiotics component and sweetener component described herein.

The film layer can be produced using a highly water-soluble polymer comprising a natural or synthetic water-soluble polymer. The polymer preferably has good film moldability, produces a soft flexible film, and is safe for pet consumption. One such polymer can be a water-soluble cellulose derivative like hydroxypropyl cellulose (HPC), methyl cellulose, hydroxypropyl alkylcellulose, carboxymethyl cellulose or the salt of carboxymethyl cellulose. Or, the polymer can comprise an acrylic acid copolymer or its sodium, potassium or ammonium salt. The acrylic acid copolymer or its salt can be combined with methacrylic acid, styrene or vinyl type of ether as a comonomer, poly vinyl alcohol, poly vinyl pyrrolidone, polyalkylene blycol, hydroxy propyl starch, alginic acid or its salt, poly-saccharide or its derivatives such as trangacanth, bum gelatin, collagen, denatured gelatin, and collagen treated with succinic acid or anhydrous phthalic acid.

The following can also, without limitation, be used to produce the film layer: pullulan, maltodextrin, pectin, alginates, carrageenan, guar gum, other gelatins, etc.

The thickness of the film layer can vary as desired, but typically is in the range of 0.01 mm to 3.00 mm, preferably 0.03 mm to 1.00 mm.

The applied coating can be applied to one or both sides of the film layer. The film layer includes upper outer surface on the top of the film layer and includes a lower outer surface on the bottom of the film. The upper outer surface is generally parallel to the lower outer surface. The top of the film is generally parallel to the bottom of the film.

In one embodiment the edible film can comprise a first layer and a second layer secured to each other along at least a portion of a periphery of said layers to form an interior volume between said layers and an opening that can receive the applied coating. The layers can then be sealed entirely around the periphery of said layers using methods of sealing that are well known in the art. Generally, these include the use of a heat sealer.

### EXAMPLES

The following examples are provided to illustrate the invention and are not intended to limit the scope thereof in any manner.

### Example 1

A composition of the present invention comprises the following individual components at the indicated amounts:

| Component | Amount (by weight percent) |
|---|---|
| Cocoa Butter | 3.8 |
| Bifidobacterium infantis | 1 |
| Sorbitol (70% solution in water) | 95.2 |

The cocoa butter is heated to a temperature of 100° C. for 1 hour, and is then cooled to 40° C. The probiotic microorganism is added to the cocoa butter in a glove box at 10% relative humidity. The sorbitol is heated to 204° C., and is then cooled to 49° C. at 12% relative humidity. The sorbitol is mixed with the cocoa butter and probiotic microorganism mixture to provide a uniformly distributed material. This material is poured into a plurality of molds of desirable shape and size and allowed to further cool. A single dose of the composition, comprising approximately 8×10⁷ CFU of probiotic microorganism/gram of composition, is dosed once daily, with food, to a mammal for gastrointestinal health benefits.

### Example 2

A composition of the present invention comprises the following individual components at the indicated amounts:

| Component | Amount (by weight percent) |
|---|---|
| Cocoa Butter | 3.8 |
| Bifidobacterium infantis | 0.9 |
| Sorbitol (70% solution in water) | 93.7 |
| Anhydrous Citric Acid | 1.3 |
| Raspberry Flavor | 0.2 |
| FD&C Red Food Coloring | 0.1 |

The composition is prepared as follows: about 75% (by weight) of the cocoa butter is heated to 100° C. for about 1 hour, and is then cooled to 40° C. About 50% (by weight) of the Bifidobacterium infantis is added to the cocoa butter in a glove box at 10% relative humidity. The sorbitol is heated to 204° C. and is then cooled to 49° C. at 12% relative humidity. The mixture of cocoa butter and Bifidobacterium infantis, the citric acid, the raspberry flavor, and the food coloring is mixed with the sorbitol to provide a uniformly distributed material. This material is rolled into a plurality of sticks each of suitable size for a pet supplement.

### Example 3

A composition of the present invention comprises the following individual components at the indicated amounts:

| Component | Amount (by weight percent) |
|---|---|
| Cocoa Butter | 11.3 |
| Bifidobacterium animalis | 1.3 |
| Culturetech 064, commercially available | 2.7 |
| from Foremost | |
| Palm Kernel Oil | 2.7 |
| Creamy White Coating, commercially | 30.3 |
| available from Blommer | |
| Lactic Acid Powder, commercially | 0.2 |
| available from Purac | |
| Sugar | 49.4 |
| Coating Gum L Solution (25%) | 0.6 |
| Titanium Dioxide | 0.4 |
| Orange Opacolor, commercially available | 1.1 |
| from Colorcon | |
| Carnauba Wax | Trace for polishing |
| | external surface of |
| | composition |

The composition is prepared as follows: about 60% (by weight) of the cocoa butter is heated to 100° C. for about 1 hour, then cooled to 40° C. About 50% (by weight) of the Bifidobacterium animalis is added to the cocoa butter in a glove box at 10% relative humidity. The Culturetech 064 (heated overnight in an oven at 82° C.), the palm kernel oil (at 121° C.), lactic acid powder (heated overnight in an oven at 82° C.), and creamy white coating (spun-dried overnight at about 60° C.) are mixed together at a temperature of 35° C. for about 30 minutes to 1 hour to provide a white coating mixture. The remaining Bifidobacterium animalis and about one-half of the remaining cocoa butter are comminuted into pieces of about 1-2 mm in diameter and dispersed through the white coating mixture. The final mixture is poured into cups and is cooled to 15° C. to solidify. The mixture is rounded into balls for 3 hours in a revolving pan at ambient environmental conditions. The sugar is added to form a coating on the balls. The balls are cooled in a plastic bag at a temperature of about 5° C. and are then coated with remaining cocoa butter at about 32° C. The coated balls are then placed into a revolving pan and pre-coated for sugar coating by evenly distributing the coating gum L solution. The balls are dried for 16 hours. A sugar solution containing the titanium dioxide is then used to apply a white syrup to the balls, followed by application of a sugar solution containing the orange Opacolor. The balls are again dried for 16 hours and then polished with carnauba wax.

### Example 4

The pet food composition can be a pet supplement that can be an edible film. The edible film can be prepared as follows: the Edible film can be obtained from Watson Foods, West Haven, Conn., with Aw (water activity)<0.2. The film (56 mm×60 mm) can be made by combining 2 layers of edible polymeric material and sealing at least a portion of the periphery of the layers to form an interior volume between the layers and an opening that can receive an applied coating. Commercially available Tallow can be preheated to 100° C. for 1 h and then cooled to 50° C. 40 g of AH C7 Probiotics can be mixed with 260 g of tallow at 50° C. Then, approximately 3 mL aliquots of the applied coating of probiotic/tallow mixture can be deposited into the interior volume through the opening for a total weight (of edible film+probiotic mix) of 2.5-3.0 g. The edible film can then be transferred to an anaerobic chamber (oxygen<500 ppm), heat sealed entirely around the periphery of the layers using a commercially available multi-temperature heat sealer and deposited into plastic lined aluminum pouches. The initial activity of probiotic is 1.9·10⁹ CFU/g.

What is claimed is:

1. A composition comprising:
(a) a probiotic component; and
(b) a sweetener component;
wherein the composition is substantially free of a chewing gum base.

2. The composition according to claim 1 wherein the probiotic component comprises bacteria.

3. The composition according to claim 2 wherein the bacteria comprises a genera selected from the group consisting of Bacillus, Bacteroides, Bifidobacterium, Enterococcus, Lactobacillus, and Leuconostoc, and combinations thereof.

4. The composition according to claim 3 wherein the sweetener component comprises a sweetener selected from the group consisting of monosaccharides, disaccharides, and mixtures thereof.

5. The composition according to claim 4 further comprising a coating component.

6. The composition according to claim 5 wherein the coating component comprises at least a portion of the sweetener component.

7. The composition according to claim 6 wherein the coating component comprises a disaccharide.

8. The composition according to claim 7 wherein the coating component comprises sucrose.

9. The composition according to claim 4 wherein the sweetener component comprises a monosaccharide.

10. The composition according to claim 9 wherein the sweetener component comprises a monosaccharide selected from the group consisting of sorbitol, mannitol, glucose, mannose, fructose, and mixtures thereof.

11. The composition according to claim 10 wherein the bacteria comprises a genera which is Bifidobacterium and the sweetener component comprises sorbitol.

12. The composition according to claim 11 which is a pet food composition.

13. The composition according to claim 12 wherein the pet food composition is a nutritionally balanced pet food composition.

14. The composition according to claim 12 wherein the pet food composition is a pet food supplement.

15. The composition according to claim 12 comprising from about 0.001% to about 50% of the bacteria and from about 50% to about 99% of the sorbitol, all by weight of the composition.

16. The composition according to claim 12 comprising from about 0.001% to about 10% of the bacteria and from about 50% to about 99% of the sorbitol, all by weight of the composition.

17. The composition according to claim 14, wherein the pet food supplement is an edible film.

18. The composition according to claim 17, wherein said edible film comprise a first layer and a second layer secured to each other along at least a portion of a periphery of said layers to form an interior volume between said layers and an opening that can receive an applied coating.

19. The composition according to claim 18, wherein said layers are sealed entirely around said periphery of said layers.

20. The composition according to claim 18, wherein said applied coating comprises a probiotic component; and a sweetener component.

21. A method of enhancing health in a mammal comprising oral administration of the composition according to claim 1 to the mammal.

22. The method according to claim 21 wherein the mammal is a pet, wherein enhancement of health is enhancement of gastrointestinal health and wherein the oral administration is at least once weekly.

23. The method according to claim 21 wherein the oral administration is from about once daily to about four times daily.

24. The method according to claim 21 wherein the oral administration is at least once monthly.

25. The method according to claim 21 wherein the oral administration is ad libitum.
